(19) United States
(12) Patent Application Publication
(10) Pub. No.: US 2008/0172942 A1
(43) Pub. Date: Jul. 24, 2008

(54) INTEGRATION OF SULFUR RECOVERY PROCESS WITH LNG AND/OR GTL PROCESSES

(75) Inventors: Dennis J. O'Rear, Petaluma, CA (US); Lisa Paige Hawker, Oakland, CA (US)

Correspondence Address: CHEVRON CORPORATION, P.O. BOX 6006, SAN RAMON, CA, 94583-0806, US

(73) Assignee: Chevron U.S.A. Inc.

(21) Appl. No.: 11/958,414

(22) Filed: Dec. 18, 2007

Related U.S. Application Data
(60) Provisional application No. 60/871,491, filed on Dec. 22, 2006.

(51) Int. Cl. C01B 3/24

(52) U.S. Cl. 48/127.5

(57) ABSTRACT

An improved integrated process for H₂S-containing natural gas conversion comprising purification process which generates a H₂S-rich gas stream and purified natural gas and an H₂S conversion process which generates energy, solid sulfur, and a sulfur-plant tail gas, and an energy-consuming natural gas conversion process selected from the group consisting of liquefaction of the purified natural gas to make LNG, synthesis gas production by partial oxidation of the purified natural gas with oxygen and combinations. The energy consuming step in the liquefaction process is separation of air to give oxygen. At least a portion of the energy release in the H₂S conversion process is used to supply at least a portion of the energy needed in the energy-consuming natural gas conversion process. The energy from the H₂S conversion process can be in the form of electricity or preferably steam. A further improvement can be obtained by using at least a portion of the oxygen used for partial oxidation in the syngas production in the H₂S conversion process or in processes to assist in further removal of sulfur from the sulfur-plant tail gas. A further additional improvement can be made by using hydrogen to assist in further removal of sulfur from the sulfur-plant tail gas where the hydrogen is derived from one or more of several of locations in the natural gas conversion process. The synthesis gas can be used to generate a range of products from different processes selected from the group consisting of fuels, chemicals, solvents, lubricant base oils and waxes by using the Fischer-Tropsch process and methanol by using the methanol synthesis process, and combinations thereof. The methanol can be further processed yield aromatics by the Methanol to Gasoline Process or to give ethylene and propylene by the Methanol to Olefins process. The ethylene and propylene can be converted to the respective polymers.

### BACKGROUND OF THE INVENTION

Natural gas is found in many locations around the world. However in many locations transportation by conventional pipeline to markets is possible. The natural gas must be converted to a form that can be transported. Typical conversion processes include liquefaction to make LNG, synthesis gas generation followed by a synthesis gas conversion process and combinations. The liquefaction of natural gas requires significant energy to compress the gas during the liquefaction process. Likewise in synthesis gas production, the synthesis gas is made by partial oxidation of the natural gas with oxygen. The preparation of the oxygen from air takes significant amounts of energy. Typically the energy for these processes is provided from the natural gas itself, but this reduces the amount of natural gas that can be transported to markets.

Natural gas also is frequently contaminated, usually with sulfur containing compounds such as hydrogen sulfide (H₂S). Prior to conversion, the natural gas must be purified and this process yields a H₂S-rich gas by-product stream. Hydrogen sulfide is a highly toxic gas and it cannot be disposed of as such. The H₂S-rich gas stream is typically converted to sulfur by a H₂S conversion process.

An excellent reference to the purification of natural gas and conversion of H₂S into sulfur is found in Kirk Othmer.

H₂S conversion processes, such as the Claus process, a portion (approximately one-third) of the H₂S is oxidized in an exothermic reaction to SO₂; with energy as a by-product. The energy is typically in the form of steam.

2H₂S+3O₂→2SO₂+2H₂O

The SO₂ and the unreacted H₂S are reacted in a series of reactors to form elemental sulfur which is condensed and converted to a solid form for disposal.

2H₂S+SO₂→3S+2H₂O

The Claus process by itself is not 100% effective in converting all H₂S into elemental sulfur. Typical recoveries up to about 97% can be achieved. The remainder of the H₂S and SO₂ are present in the Claus plant tail-gas. Often the concentrations of these species in the tail-gas are too high for direct disposal or by disposal in a flare. Rather additional processing steps must be used.

Typical improvements to the Claus process include the following tail-gas processing processes:
In Comprimo's Superclaus and Parson's Hi-Activity processes a catalytic reactor is used in place of or in addition to one of the last Claus reactors to directly oxidize H₂S with oxygen to sulfur. With this the overall recover of sulfur can approach 99.2%.
In the Shell Claus off-gas treatment (SCOT) process and the Beavon process, the sulfur species in the tail-gas are first reduced back to H₂S. The H₂S is then re-adsorbed into an amine, and then desorbed to form a second H₂S-rich gas stream. This second H₂S-stream is recycled to the Claus reactors for conversion to sulfur. The overall recovery of sulfur is greater than 99.8%.

Alternatively, the H₂S in the second H₂S-rich gas stream can be processed in a Stretford where it is adsorbed into an aqueous solution of sodium carbonate, sodium vanadate, and an oxidation catalyst. The H₂S reacts to form sulfur, which is recovered, and a solution of a reduced vanadium species. The reduced vanadium is oxidized back to sodium vanadate. In U.S. Filter Company's Lo-Cat process the vanadium used in the Stretford process is replace with an aqueous iron compound.

In each of these H₂S conversion and tail gas cleanup processes oxygen is needed for oxidation of H₂S or to regenerate catalysts. Likewise a reducing agent is needed in the SCOT and Beavon processes to convert SO₂ back to H₂S. Likewise in the Superclaus and Hi-Activity processes, reduction of SO₂ back to H₂S will assist in sulfur conversion. While the oxygen used in their Claus, Superclaus, Hi-Activity, Stretford and Lo-Cat processes can be supplied by air, enriched air or essentially pure oxygen itself have been claimed to benefit the operations. A source of the oxygen (at a concentration greater than air) and the reducing reagent are desired.

### DEFINITIONS

Synthesis gas is a mixture comprising hydrogen and carbon monoxide and optionally other gases such as water and carbon dioxide.

Fischer-Tropsch include both High Temperature: (HTFT) and Low Temperature Fischer-Tropsch (LTFT) processes, but the preferred Fischer-Tropsch process is a flow Temperature Fischer-Tropsch process, most preferably operated in a slurry bed. The HTFT processes operate at temperatures of 250° C. and above, while the LTFT process operates at below 250° C.

Waxy as in Waxy Fischer-Tropsch product means containing greater than 20% normal hydrocarbonaceous compounds (paraffins, olefins alcohols) of carbon number equal to or greater than 5, preferably greater than 50%, most preferably greater than 75%.

LNG (natural gas liquefaction) and Air Separation are described in Kirk Othmer, Vol. 8, pages 40-65 entitled Cryogenic Technology, incorporated herein by reference. More specifically, these processes are described in Kirk Othmer reference sections discussing LNG is on page 49, section 3.3. Air separation starts on page 43, section 3.1. the preferred air separation process is the “pumped LOX” process which supplies oxygen at the pressure needed for use in the synthesis gas production process.

Hydrogen Production and H₂S Recovery are described in Kirk Othmer, Vol. 13, pages 759-808, entitled Hydrogen, incorporated herein by reference. More specifically, these processes are described in Kirk Othmer reference sections discussing hydrogen production is preferably obtained by a Steam Methane Reforming (SMR) process as defined on pages 775-780. The hydrogen recovery process can be done by either a Pressure Swing Adsorption (PSA) or membrane separation processes as defined on pages 794-796.

### SUMMARY OF THE INVENTION

The invention comprises integrating processes for H₂S conversion and natural gas conversion processes such as Fischer-Tropsch, LNG, and the like to achieve overall integration process improvements.
Providing energy needed in the natural gas liquefaction or the air separations processes used as part of the synthesis gas production process from the energy released in the H₂S conversion operations can reduce the amount of natural gas needed to power the natural gas conversion operations, and thus increase the proportion of natural gas converted into products.
Oxygen (at a concentration greater than air) needed in the Claus, Superclaus, and Hi-Activity processes for H₂S oxidation and for regeneration of catalysts used in the Stretford and Lo-Cat processes can be provided by the oxygen recovered in the air separation plant used to provide oxygen to the syngas generation process.
Hydrogen can be used as a reducing gas to convert SO₂ hack to H₂S in the SCOT and Beacon processes. This can be recovered from the synthesis gas, tail gas from a Fischer-Tropsch process, or unreacted gas from the upgrading processes used to convert Fischer-Tropsch products into fuels, chemicals, solvents, lubricant base oils and waxes.

### BRIEF DESCRIPTION OF THE DRAWINGS

FIG. 1 illustrates the energy integration aspect of the invention.

### Description of the Invention

FIG. 2 illustrates the oxygen integration aspects of the invention.

FIG. 3 illustrates the hydrogen integration aspects of the invention.

### PREFERRED EMBODIMENTS OF THE INVENTION

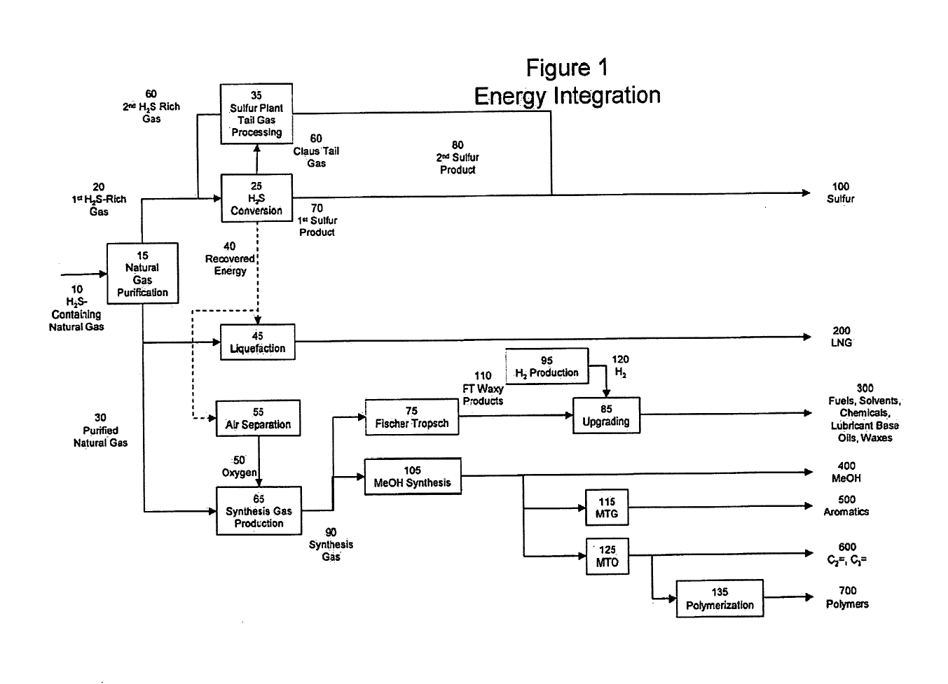

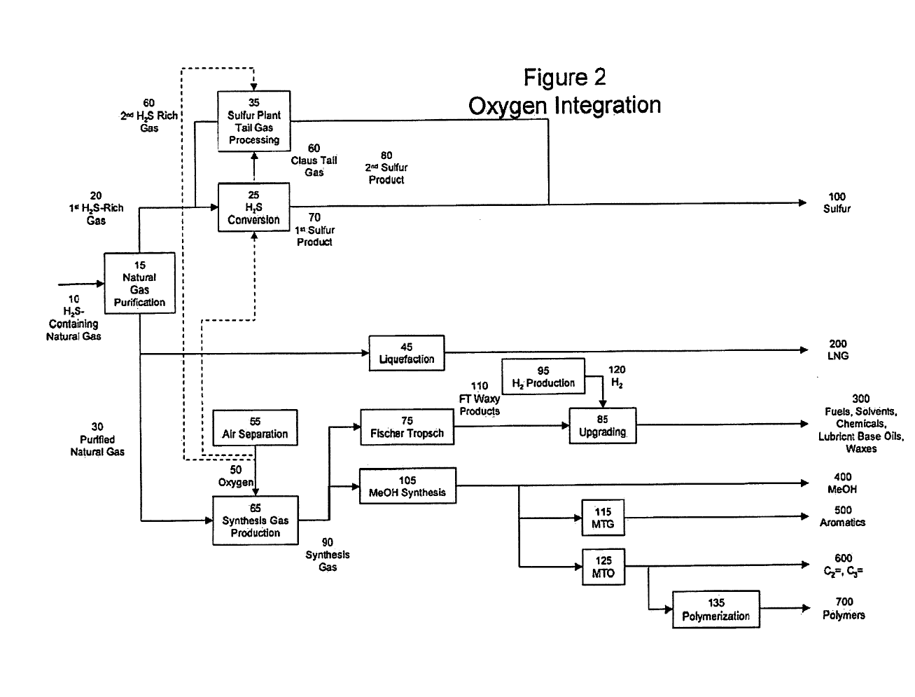

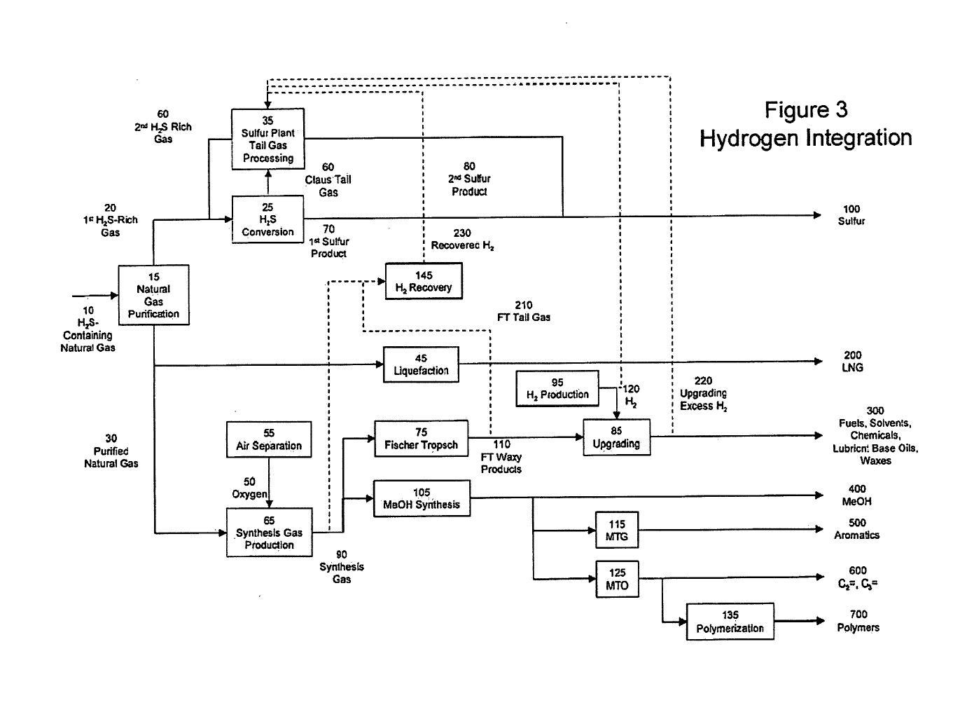

FIG. 1 illustrates how energy produced in the hydrogen sulfide conversion, process can be used, inter alia, in the natural gas conversion process. A H₂S-containing natural gas stream (10) is fed to a natural gas purification process (15) that preferably uses an amine. A purified natural gas containing less than 1 ppm H₂S by volume (30) is produced along with a first H₂S-rich gas (20). The first H₂S-rich gas is processed in a H₂S conversion process (25) where in a portion of the H₂S is oxidized to SO₂ and the SO₂ is then reacted with at least a portion of the remaining H₂S to form a first sulfur product (70), recovered energy (40) in the form of steam, and a sulfur-plant tail gas (60). The first sulfur product then is used to form the final sulfur product (100). Optionally at least a portion of the sulfur-plant tail gas is processed in a sulfur-plant tail gas process (35) for form an optional second sulfur product (80) and an optional second H₂S rich gas (60). The H₂S sulfur product is combined with the first sulfur product to form the final sulfur product. The second H₂S-rich gas is combined with the first 112S right gas and processed in the H₂S conversion process.

The purified natural gas is then processed in either or both of the following natural gas conversion processes: liquefaction (45) and/or synthesis gas production (65). The product from the liquefaction process is liquefied natural gas (200) also known as LNG. Oxygen (50) needed for the synthesis gas production is prepared in an air separation process (55).

Energy is needed for the liquefaction and air separations processes. At least a portion of the energy needed for these processes is provided by the energy recovered in the H₂S conversion process. Energy for the liquefaction and air separations processes and not provided by the H₂S conversion process is provided from the purified natural gas. The proportion of energy provided from the H₂S conversion process is between 0.1 and 50%, preferably between 1 and 25%, and most preferably between 2 and 10%.

The product from the synthesis gas production is synthesis gas (90) which is processed in either or both of a Fischer-Tropsch process (75) or a methanol synthesis process (1105). The product from the Fischer-Tropsch process is a waxy product (110) which is upgraded in an upgrader (85) to produce upgraded products (300) which can consist of fuels (jet, diesel, kerosene), solvents, chemicals, lubricant base oils, waxes and combinations. The upgrading process consumes hydrogen (120) which is produced in a hydrogen production process (95) using purified natural gas (30) supplied by a line not shown. The hydrogen supplied to the upgrader is not completely consumed, and excess hydrogen (220) is produced in the upgrading reactor.

The product from the methanol synthesis process is methanol (400). The methanol can be further reacted in a methanol to gasoline process (115) to make aromatics (500) consisting of benzene, toluene, zylenes, C₉ aromatics and C₁₀ aromatics and combinations. These aromatics can be used as aromatic chemicals or in gasoline. Alternatively the methanol can be reacted in a methanol to olefins process (125) to yield an olefinic product (600) consisting of ethylene, propylene, butanes and combinations. Ethylene is the preferred product. Optionally the olefins can be reacted in polymerization processes (135) to yield polymers (700) consisting of polyethylene and polypropylene.

In this embodiment illustrated in FIG. 2, at least a portion of the oxygen (50) from the air separation process (55) is used in the sulfur plant tail gas process (35), the H₂S conversion unit (25) and combinations of these two. Elements from FIG. 1 were carried over in FIG. 2. The oxygen is used for oxidation of H₂S, regeneration of catalysts or combinations of these two.

In this embodiment illustrated in FIG. 3, hydrogen is used in the sulfur-plant tail gas process (35) to reduction of SO₂ back to H₂S. Elements from FIGS. 1 and 2 were carried over in FIG. 3. The hydrogen can come from any of three sources or combinations: from a H₂ recovery process (145) that purifies synthesis gas (90) from the H₂ production process (95), and excess hydrogen (220) remaining in the effluent of the upgrading process (120). The H₂ recovery process reduces the carbon oxide content of the synthesis gas to make it more suitable for use in reduction SO₂ back to H₂S. The preferred source of hydrogen is the excess hydrogen from the upgrader. This hydrogen contains low levels of carbon oxides, but contains some light hydrocarbons (methane to butane). The purity of hydrogen in this stream is less than 90 mole percent, preferably between 10 and 75 mole percent. The lower level of purity of this stream makes it less valuable for use in the upgrader and it typically used as fuel. However, it is useful for reduction of SO₂ back to H₂S in the sulfur plant tail gas process.

The synthesis gas used in the H₂ recovery process can be obtained from either of two locations or both: directly from the synthesis gas process (65) and recovered from the effluent from the Fischer-Tropsch process (75). The Fischer-Tropsch process does not convert all of the synthesis gas fed to the unit. The remaining unconverted-synthesis gas is referred to as a Fischer-Tropsch tail gas. This material it typically used as fuel. If hydrogen is supplied to the sulfur plant tail gas process by the H₂ recovery process using synthesis gas, the preferred source of the synthesis gas is the tail gas from the Fischer-Tropsch process.

The invention is claimed hereinafter. Modifications obvious to the ordinary skilled artisan are intended to be within the scope and interpretation of the claims. For example sulfurous biomass can be a source to make synthesis gas.

What is claimed is:

1. A process for conversion of H₂S-containing natural gas comprising:
a. purification of the H₂S-containing natural gas to give a purified natural gas and a first H₂S-rich gas;
b. converting at least a portion of the H₂S in the first H₂S-rich gas in an H₂S conversion process using oxygen to SO₂ and energy, and
c. converting at least a portion of the purified natural gas in natural gas conversion processes selected from the group consisting of liquefaction, synthesis gas production, and combinations; wherein the synthesis gas production uses oxygen supplied from an air separation process,
wherein at least a portion of the energy produced in step (b) provides at least a portion of the energy needed in energy-consuming processes selected from the group consisting of liquefaction, air separation, and combinations.

2. A process according to claim 1 wherein the purified natural gas contains less than 1 ppm sulfur.

3. A process according to claim 1 wherein the energy supplied to the energy-consuming processes from step (b) is between 0.1 and 50% of the energy needs of these energy-consuming processes.

4. A process according to claim 3 wherein the energy supplied to the energy-consuming processed from step (b) is between 1 and 25% of the energy needs of these energy-consuming processes.

5. A process according to claim 4 wherein the energy supplied to the energy-consuming processes from step (b) is between 2 and 10% of the energy needs of these energy-consuming processes.

6. A process according to claim 1 wherein the energy in step (b) is in the form of steam.

7. A process for conversion of H₂S-containing natural gas comprising:
a. purification of the H₂S-containing natural gas to give a purified natural gas and a first H₂S-rich gas;
b. Converting at least a portion of the H₂S in the first H₂S-rich gas in an H₂S conversion process using oxygen to SO₂; and
c. converting at least a portion of the oxygen produced in the air separation process is used to supply oxygen in oxygen the H₂S conversion process of step (b).

8. The process of claim 7 further comprising:
a. producting a sulfur-containing sulfur-plant tail gas;
b. removing at least a portion of the sulfur from the sulfur-containing sulfur-plaint tail gas in a sulfur-plant tail gas process using a catalyst; and
c. regenerating the catalyst with oxygen,
wherein at least a portion of the oxygen produced in the air separation process is used to supply oxygen needed for the regeneration of the catalyst.

9. A process for conversion of H₂S-containing natural gas comprising:
a. purification of the H₂S-containing natural gas to give a purified natural gas and a first H₂S-rich gas;
b. converting at least a portion of the H₂S in the first H₂S-rich gas in an H₂S conversion process using oxygen to SO₂ and a SO₂-containing sulfur-plant tail gas;
c. reducing at least a portion of the SO₂ in the SO₂-containing sulfur-plant tail gas using a H₂-containing gas to H₂S;
d. removing at least a portion of the H₂S in the product from step (c);
e. converting at least a portion of the purified natural gas in a synthesis gas process to form a H₂-containing synthesis gas;
f. converting at least a portion of the H₂-containing synthesis gas in a Fischer-Tropsch process to form a waxy product and a H₂-containing Fischer-Tropsch tail gas; and
g. converting at least a portion of the waxy product from step (f) with H₂ to form products and an H₂-containing excess gas product of step (g), H₂ from the H₂ production process,
wherein at least a portion of the H₂-containing gas needed in step (c) is supplied from the group consisting of H₂-containing synthesis gas of step (f), H₂-containing Fischer-Tropsch tail gas of step (f), H₂-containing excess gas product of step (g), H₂ from the H₂ production process, and combinations.

10. A process according to claim 9 wherein at least a portion of the H₂-containing gas needed in step (c) is supplied from H₂-containing excess gas product of step (g).

11. A process according to claim 10 wherein the H₂ content of the H₂-containing excess gas product of step (g) is less than 90 mole percent.

12. A process according to claim 11 wherein the H₂ content is between 10 and 75 mole percent.

13. A process according to claim 9 wherein at least a portion of the H₂-containing gas needed in step (c) is supplied from the group consisting of H₂-containing synthesis gas of step (f), H₂-containing Fischer-Tropsch tail gas of step (f), and combinations; and wherein the H₂-containing gas needed in step (c) is purified prior to use to reduce the content of carbon oxides, wherein at least a portion of the oxygen produced in the air separation process is used to supply oxygen in oxygen the H₂S conversion process of step (b).
